(19) United States
(12) Patent Application Publication
(10) Pub. No.: US 2026/0334446 A1
(43) Pub. Date: Oct. 29, 2026

(54) TACKLEBOX APPARATUS

(71) Applicant: Joseph Morris, Lamesa, TX (US)

(72) Inventor: Joseph Morris, Lamesa, TX (US)

(21) Appl. No.: 19/191,797

(22) Filed: Apr. 28, 2025

(51) Int. Cl. A01K 97/06

(52) U.S. Cl. CPC A01K 97/06

(57) ABSTRACT

A tacklebox apparatus for storing lures and charging electronic devices includes a container with a body and a lid. The body has a storage compartment defined therein which is open at a top side of the body and has a floor surface at a bottom of the storage compartment. The lid is positionable in a closed position in which the lid covers the storage compartment of the body. A charging device is mounted to the container, comprising a support pad for supporting an electronic device and a charging circuit configured to charge the electronic device when the support pad supports the electronic device. A retaining pad is provided which is configured to be positionable to retain the electronic device on the support pad of the charging device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tackleboxes and more particularly pertains to a new tacklebox for storing lures and charging electronic devices.

### (2) Description of Related Art Including Information Disclosed Under 37 CFR 1.97 and 1.98

Myriad tackleboxes are disclosed by the prior art. However, the prior art fails to disclose a tacklebox which has a charging device for charging mobile phones and other electronic devices and a retaining pad which is positionable against a selected device to secure the selected device to a support pad of the charging device.

### BRIEF SUMMARY OF THE INVENTION

An embodiment of the disclosure meets the needs presented above by generally comprising a container with a body and a lid. The body has a storage compartment defined therein which is open at a top side of the body and has a floor surface at a bottom of the storage compartment. The lid is positionable in a closed position in which the lid covers the storage compartment of the body. A charging device is mounted to the container, comprising a support pad for supporting an electronic device and a charging circuit configured to charge the electronic device when the support pad supports the electronic device. A retaining pad is provided which is configured to be positionable to retain the electronic device on the support pad of the charging device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tacklebox apparatus according to a first embodiment of the disclosure.

FIG. 2 is a top in-use view of the first embodiment of the disclosure.

FIG. 3 is a top view of the first embodiment of the disclosure.

FIG. 4 is a side view of the first embodiment of the disclosure.

FIG. 5 is a front view of the embodiment of the disclosure.

FIG. 6 is a top view of a second embodiment of the disclosure in which an access door is shown in a closed position. The second embodiment includes additional elements shown in FIGS. 6 and 7, but all other features shown in FIGS. 1 through 5 may be incorporated into the second embodiment.

FIG. 7 is a top view of an embodiment of the disclosure in which the access door is shown in an open position.

FIG. 8 is a block diagram of an embodiment of the disclosure.

### DETAILED DESCRIPTION OF THE INVENTION

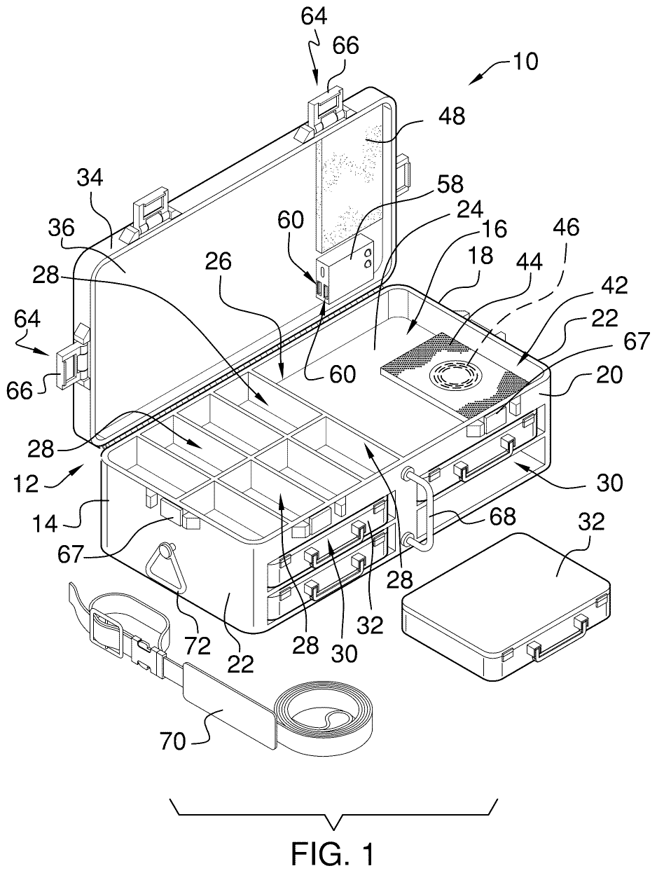

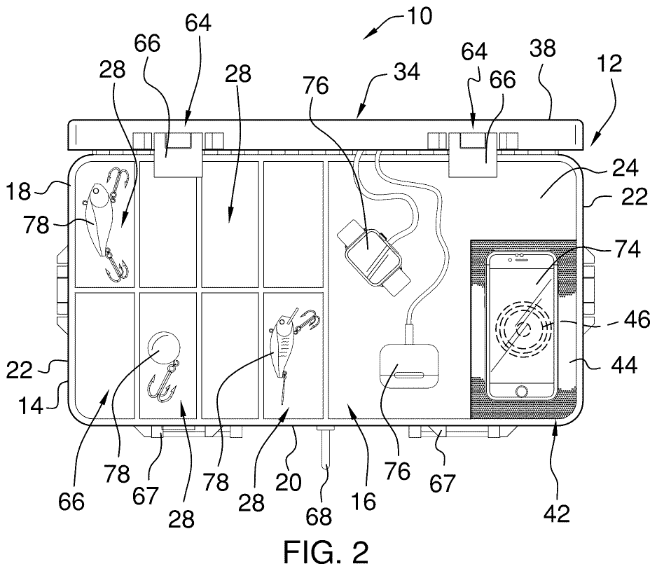

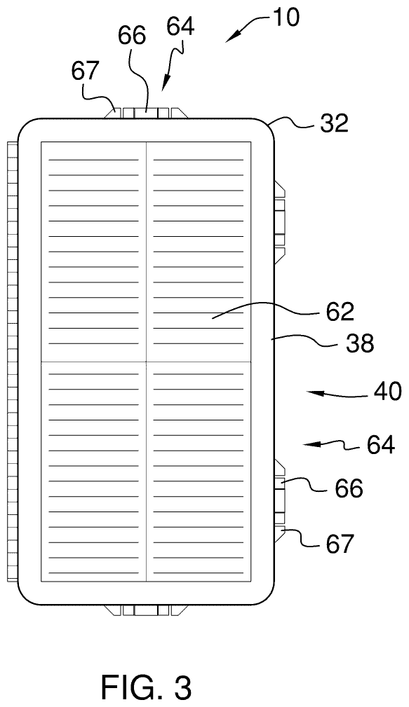

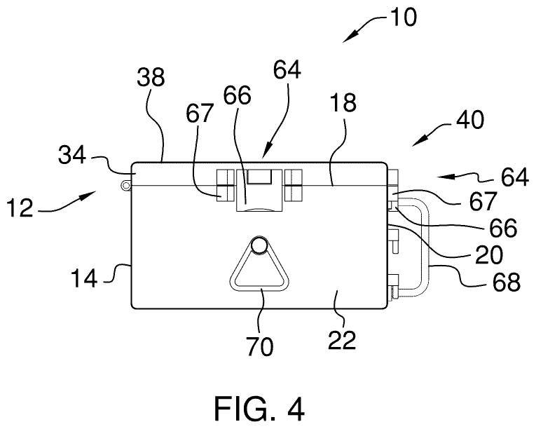

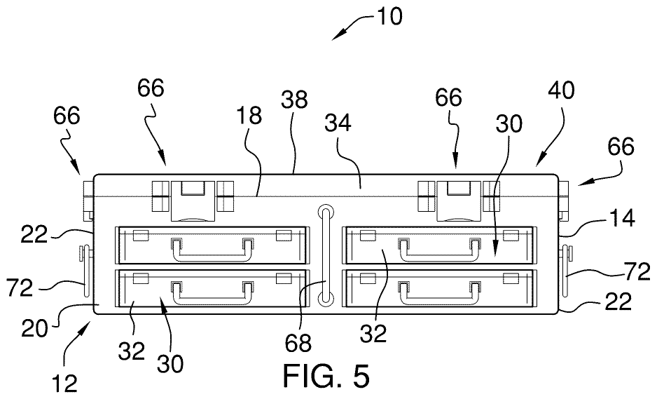

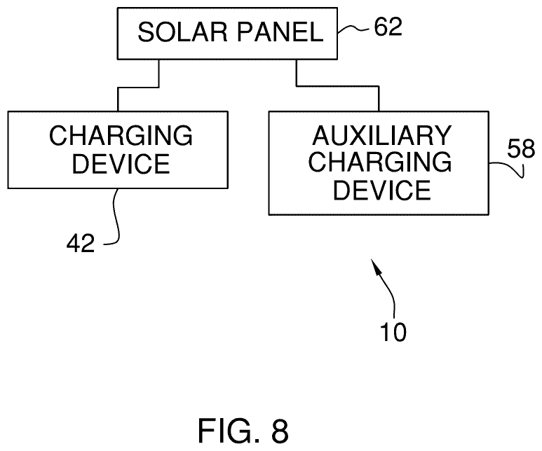

With reference now to the drawings, and in particular to FIGS. 1 through 8 thereof, a new tacklebox embodying the principles and concepts of an embodiment of the disclosure and generally designated by the reference numeral 10 will be described.

As best illustrated in FIGS. 1 through 8, the tacklebox apparatus 10 generally comprises a container 12 that has a body 14 and a lid 34. The body 14 has a storage compartment 16 defined therein which is open at a top side 18 of the body 14, and the lid 34 is positionable in a closed position 40 in which the lid 34 covers the storage compartment 16 of the body 14. The lid 34 is pivotably mounted to the body 14 but may be releasably mountable to the body 14 in the closed position 40 or otherwise movably mounted to the body 14 in other embodiments. The body 14 has a floor surface 24 at a bottom of the storage compartment 16 and a plurality of dividers 26 coupled to the floor surface 24. The dividers 26 extend away from the floor surface 24 to the top side 18 of the body 14 and have a plurality of lure compartments 28 defined therebetween for storing lures 78. The lure compartments 28 have equal sizes and shapes to each other. The body 14 also has a plurality of bays 30 which extend into a front side 20 of the body 14. A plurality of lure boxes 32 for storing additional lures are provided, and each lure box 32 is positionable in an associated bay 30 of the plurality of bays 30 of the body 14 of the container 12.

A charging device 42 is mounted to the container 12 and comprises a support pad 44 for supporting an electronic device 74 and a wireless charging circuit 46 embedded in the support pad 44. A retaining pad 48 is positionable against the electronic device 74 when the electronic device 74 is charging on the support pad 44 such that the retaining pad 48 retains the electronic device 74 on the support pad 44.

With reference to FIG. 1, the charging device 42 of a first embodiment of the disclosure is positioned on the floor surface 24 of the body 14 in the storage compartment 16 of the body 14. The retaining pad 48 is positioned on an interior side 36 of the lid 34 in the first embodiment, and the retaining pad 48 is positioned over the supporting pad when the lid 34 is in the closed position 40.

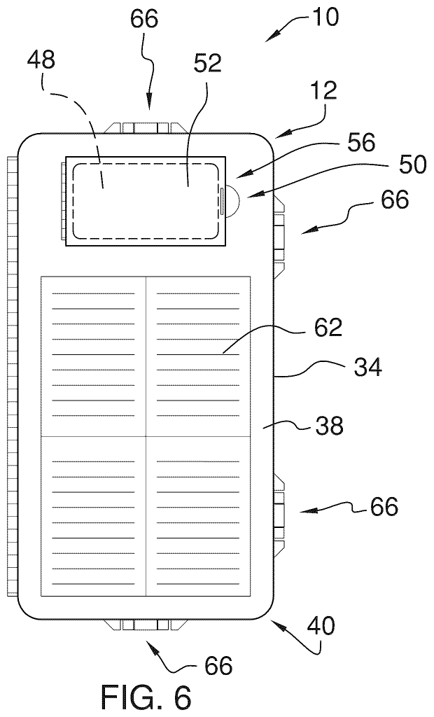

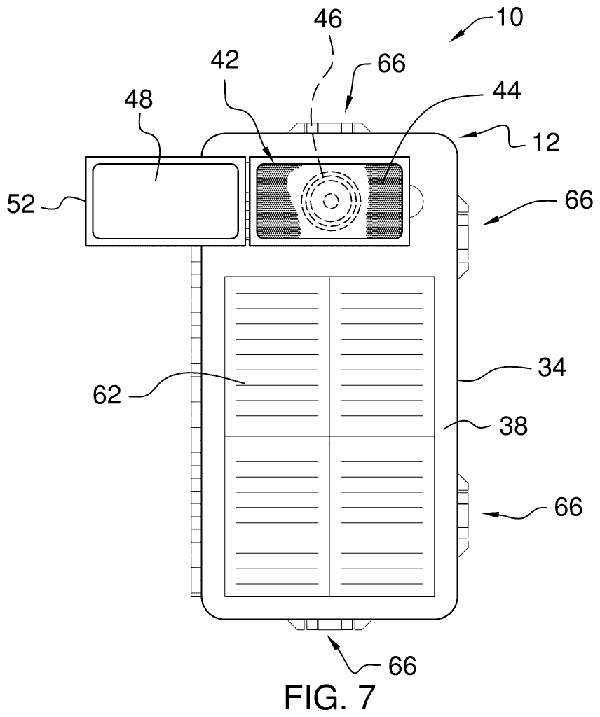

In a second embodiment of the disclosure as seen in FIGS. 6 and 7, the lid 34 has a recess 50 which extends into an exterior side 38 of the lid 34, and the charging device 42 is positioned in the recess 50. An access panel 52 is pivotably mounted to the lid 34 and is securable in a closed position 56 over the recess 50 of the lid 34. The retaining pad 48 is positioned on an inner side 54 of the access panel 52. The access panel 52 may be removably mountable to the lid 34 or otherwise movably mounted to the lid 34 in other embodiments. The access panel 52 may close with a snap fit or otherwise and may form a water-impermeable seal with the lid 34 when closed.

The support pad 44 comprises a thermal mass material which may be used to prevent excessive heat to build up in the electronic device 74 being charged by absorbing the heat generated during charging of the electronic device 74. The thermal mass material may comprise hydroxyethyl cellulose, sodium polyacrylate, or the like. The retaining pad 48 comprises a resiliently deformable material and is positioned to deform around edges of the electronic device 74 to prevent sliding or other movements of the electronic device 74 with respect to the support pad 44. In some embodiments, the charging device 42 may comprise a charging cord or the like which is connectable to the electronic device 74 when the electronic device 74 is set on the support pad 44.

An auxiliary charging device 58 is mounted to an interior side 36 of the lid 34 for charging additional electronic devices 76 in the storage compartment 16. The auxiliary charging device 58 comprises charging ports 60 to which additional electronic devices 76 may electrically couple via charging cords.

A solar panel 62 is coupled to the exterior side 38 of the lid 34 and is electrically coupled to the charging device 42 and the auxiliary charging device 58. A battery, a capacitor, or other energy storage device may also be provided and electrically coupled to the solar panel 62, the charging device 42, and the auxiliary charging device 58. In such embodiments, the solar panel 62 may charge the battery or other energy storage device which is then used to charge the electronic device 74 and other electronic devices. In some embodiments, the battery may be charged by external power sources, and the solar panel 62 may not be included.

A plurality of latches 64 is coupled to the container 12. Each latch 64 comprises a first mating member 66 mounted on the lid 34 and a second mating member 67 mounted on the body 14. When the lid 34 is closed and latched, the lid 34 may form a water-impermeable seal with the body 14. A handle 68 is mounted to the front side 20 of the body 14, and a carrying strap 70 is removably couplable to the container 12 via a pair of mounting rings 72. Each mounting ring 72 is positioned on an associated one of a pair of lateral sides 22 of the body 14. The carrying strap 70 may be threaded through each mounting ring 72. Other fasteners may removably mount the carrying strap 70 to the container 12 in other embodiments.

In use, lures 78 may be stored in the lure compartments 28 and the lure boxes 32. Electronic devices may be charged by the charging device 42 or by the auxiliary charging device 58. By securing an electronic device in the storage compartment 16 of the body 14 or the recess 50 of the lid 34, the electronic device may be protected from water while charging. The retaining pad 48 may be positioned to secure a selected electronic device on the support pad 44 of the charging device 42 when the charging device 42 charges the electronic device. The thermal mass of the support pad 44 of the charging device 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tacklebox apparatus comprising:
a container comprising:
a body having a storage compartment defined therein which is open at a top side of the body, the body having a floor surface at a bottom of the storage compartment; and
a lid which is positionable in a closed position in which the lid covers the storage compartment of the body;
a charging device mounted to the container, the charging device comprising a support pad for supporting an electronic device and a charging circuit configured to charge the electronic device when the support pad supports the electronic device; and
a retaining pad, said retaining pad being positioned on said lid opposite said charging device and having a shape such that said retaining pad covers said charging device when said lid is closed wherein said retaining pad is configured to be positionable to retain the electronic device on the support pad of the charging device.

2. The tacklebox apparatus of claim 1, wherein:
the charging device is positioned on the floor surface of the body; and
the retaining pad is positioned on an interior side of the lid, the retaining pad being positioned over the supporting pad when the lid is in the closed position.

3. The tacklebox apparatus of claim 1, wherein:
the lid has a recess which extends into an exterior side of the lid, the charging device being positioned in the recess; and
further comprising an access panel which is securable in a closed position over the recess of the lid, the retaining pad being positioned on an inner side of the access panel.

4. The tacklebox apparatus of claim 3, wherein the access panel is pivotably mounted to the lid.

5. The tacklebox apparatus of claim 1, wherein the charging circuit of the charging device comprises a wireless charging circuit.

6. The tacklebox apparatus of claim 1, wherein the support pad comprises a thermal mass material.

7. The tacklebox apparatus of claim 1, wherein the body of the container comprises a plurality of dividers coupled to the floor surface, the plurality of dividers extending away from the floor surface to the top side of the body and having a plurality of lure compartments defined therebetween for storing lures.

8. The tacklebox apparatus of claim 7, wherein the lure compartments of the plurality of lure compartments have equal sizes and shapes to each other.

9. The tacklebox apparatus of claim 1, wherein the body having a plurality of bays which extend into a front side of the body, further comprising a plurality of lure boxes for storing additional lures, each lure box of the plurality of lure boxes being positionable in an associated bay of the plurality of bays of the body of the container.

10. The tacklebox apparatus of claim 1, wherein the lid is pivotably mounted to the body.

11. The tacklebox apparatus of claim 1, wherein the retaining pad comprises a resiliently deformable material.

12. The tacklebox apparatus of claim 1, further comprising an auxiliary charging device coupled to the container for charging additional electronic devices in the storage compartment, the auxiliary charging device comprising charging ports.

13. The tacklebox apparatus of claim 12, further comprising a solar panel coupled to the container, the solar panel being electrically coupled to the charging device and the auxiliary charging device.

14. The tacklebox apparatus of claim 13, wherein the solar panel is positioned on an exterior side of the lid.

15. The tacklebox apparatus of claim 1, further comprising a plurality of latches coupled to the container, each latch of the plurality of latches comprising a first mating member mounted on the lid and a second mating member mounted on the body.

16. The tacklebox apparatus of claim 1, further comprising a handle mounted to the front side of the body.

17. The tacklebox apparatus of claim 1, further comprising:
a carrying strap removably couplable to the container, the carrying strap being coupled to and extending between a pair of lateral sides of the body when the carrying strap is coupled to the container; and
a pair of mounting rings coupled to the container, each mounting ring being positioned on an associated one of the pair of lateral sides of the body, the carrying strap being threadable through each mounting ring of the pair of mounting rings.

18. A tacklebox apparatus comprising:
a container comprising:
a body having a storage compartment defined therein which is open at a top side of the body, the body having a floor surface at a bottom of the storage compartment and a plurality of dividers coupled to the floor surface, the plurality of dividers extending away from the floor surface to the top side of the body and having a plurality of lure compartments defined therebetween for storing lures, the plurality of lure compartments having equal sizes and shapes to each other, the body having a plurality of bays which extend into a front side of the body; and
a lid which is positionable in a closed position in which the lid covers the storage compartment of the body, the lid being pivotably mounted to the body;
a charging device mounted to the container, the charging device comprising a support pad for supporting an electronic device and a wireless charging circuit embedded in the support pad, the support pad comprising a thermal mass material;
a retaining pad, said retaining pad being positioned on said lid opposite said charging device and having a shape such that said retaining pad covers said charging device when said lid is closed wherein said retaining pad is configured to be positionable to retain the electronic device on the support pad of the charging device, the retaining pad comprising a resiliently deformable material;
an auxiliary charging device coupled to the container for charging additional electronic devices in the storage compartment, the auxiliary charging device comprising charging ports, the auxiliary charging device being mounted to an interior side of the lid;
a solar panel coupled to the container, the solar panel being positioned on an exterior side of the lid, the solar panel being electrically coupled to the charging device and the auxiliary charging device;
a plurality of lure boxes for storing additional lures, each lure box of the plurality of lure boxes being positionable in an associated bay of the plurality of bays of the body of the container;
a plurality of latches coupled to the container, each latch of the plurality of latches comprising a first mating member mounted on the lid and a second mating member mounted on the body;
a handle mounted to the front side of the body;
a carrying strap removably couplable to the container, the carrying strap being coupled to and extending between a pair of lateral sides of the body when the carrying strap is coupled to the container; and
a pair of mounting rings coupled to the container, each mounting ring being positioned on an associated one of the pair of lateral sides of the body, the carrying strap being threadable through each mounting ring of the pair of mounting rings.

19. The tacklebox apparatus of claim 18, wherein:
the charging device is positioned on the floor surface of the body; and
the retaining pad is positioned on the interior side of the lid, the retaining pad being positioned over the supporting pad when the lid is in the closed position.

20. The tacklebox apparatus of claim 18, wherein:
the lid has a recess which extends into the exterior side of the lid, the charging device being positioned in the recess; and
further comprising an access panel which is securable in a closed position over the recess of the lid, the retaining pad being positioned on an inner side of the access panel, the access panel being pivotably mounted to the lid.
